(19) United States
(12) Patent Application Publication
(10) Pub. No.: US 2020/0265341 A1
(43) Pub. Date: Aug. 20, 2020

(54) AUTOMATIC DETECTION OF LABELING ERRORS

(71) Applicant: Microsoft Technology Licensing, LLC, Redmond, WA (US)

(72) Inventors: Rushi Prafull Bhatt, Bangalore (IN); Abijith Karippale Padinjareveedu, Kadavanthara (IN); Ramanujam Madhavan, Bangalore (IN)

(21) Appl. No.: 16/278,413

(22) Filed: Feb. 18, 2019

(51) Int. Cl. G06N 20/10; G06N 7/00

(52) U.S. Cl. CPC G06N 20/10; G06N 7/005

(57) ABSTRACT

Disclosed are systems, methods, and non-transitory computer-readable media for automatic detection of labeling errors. A classification system uses a classification model to determine a classification label for a data item and compares the classification label to a classification label assigned to the data item by a human labeler. In response to determining that the classification label determined by the classification model is different than the classification label assigned by the human labeler human labeler, the classification system determines, using a model interpretability technique, a list of features that contributed to the classification model determining the classification label for the data item, and determines, based on the list of features, a probability value indicating a likelihood that the classification label determined by the classification model properly classifies the data item.

### TECHNICAL FIELD

An embodiment of the present subject matter relates generally to labelling data and, more specifically, to automatic detection of labeling errors.

### BACKGROUND

Data labelling is the process of assigning labels to data that categorizes the data. Data labelling is performed for a variety of reasons, such as categorizing data to be searched, document production during discovery, categorizing content for inclusion on a social networking site, etc. Data labelling is often performed manually by teams of human labelers. The human labelers assign labels to the data based on a set of labelling guidelines that describe how the data is to be categorized. One issue with this process is that human labelers sometimes mislabel and/or inconsistently label the data. This is may be due to a variety of reasons, such as ambiguous labelling guidelines, human fatigue, varying expertise by individual labelers, etc. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an example system configuration, wherein electronic devices communicate via a network for purposes of exchanging content and other data.

FIG. 2. is a block diagram of a collaboration system, according to some example embodiments.

FIG. 3 is a block diagram of a permission management module, according to some example embodiments.

FIG. 4 is a flowchart showing an example method of initializing permissions levels for an employment listing, according to certain example embodiments.

FIG. 5 is a flowchart showing an example method of tagging a user account to an employment listing, according to certain example embodiments.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for automatic detection of labeling errors. A classification system uses a text classification model to automatically detect labelling errors made by human labelers. The text classification model may be trained using a set of verified or unverified labelling data. The set of verified labelling data includes labels assigned to data items that have been verified for accuracy. The unverified labeling data may come from a multitude of sources including but not restricted to crowd-sourcing, external vendors, or user-generated. For example, the data items may have been reviewed and labeled with the same label by multiple labelers, indicating a high level of confidence that the data item was labeled correctly. The resulting text classification model receives a data item as input and in turn outputs probability values indicating a likelihood that each of a set of classification labels properly label the input data item. A data item is any type of data, such as a document, image, audio file, etc.

The classification system uses the text classification model to double check the classification labels assigned to data items by the human labelers. For example, the classification system uses a data item as input into the text classification system to determine a classification label for the data item (e.g., the classification label with the highest probability value) and then compares the classification label determined by the classification model to the classification label assigned to the data item by the human labeler. If the classification label determined by the text classification model matches the classification label assigned by the human labeler, the classification label assigned by the human labeler is most likely correct and no further action is taken by the classification system.

Alternatively, if the classification label determined by the text classification model does not match the classification label assigned by the human labeler, the classification label assigned by the human labeler may not be correct. In this case, the classification system may investigate further to determine whether the classification label assigned by the human labeler is correct. To accomplish this, the classification system uses a model interpretability technique to determine why the text classification model determined the classification label for the data item. A model interpretability technique (e.g., Local Interpretable Model-Agnostic Explanations (LIME)) provides data that explains how a model made a determination. For example, the model interpretability technique provides a listing of the features that contributed to the classification model determining a classification label for the data item. A feature is an individual measurable property or characteristic that is considered by a model when analyzing an input text. The text classification model analyzes a data item based on multiple features to provide the resulting probability values for the classification labels. The model interpretability technique provides a listing of the features that contributed to the classification model's determination, as well as values corresponding to the listed features that indicate a level at which the feature contributed and/or was relied upon by the text classification model in making its determination.

The classification system uses the output of the model interpretability technique to determine a probability value indicating a likelihood that the text classification model properly classified the data item (e.g., the classification label determined by the text classification model properly classifies the input data item). The classification system compares the probability value to a threshold probability value to determine whether the text classification model properly classified the data item. For example, if the probability value is below the threshold probability value, the classification system may determine that the text classification model did not properly classify the data item and the classification label assigned by the human labeler may be used to classify the data item. In contrast, if the probability value transgresses the threshold probability value (e.g., the probability value meets or is greater than the threshold probability value), the classification system may determine that the text classification model did properly classify the data item. In this case, the classification system may use the classification label determined by the text classification model, rather than the classification label determined by the human labeler, to classify the data item.

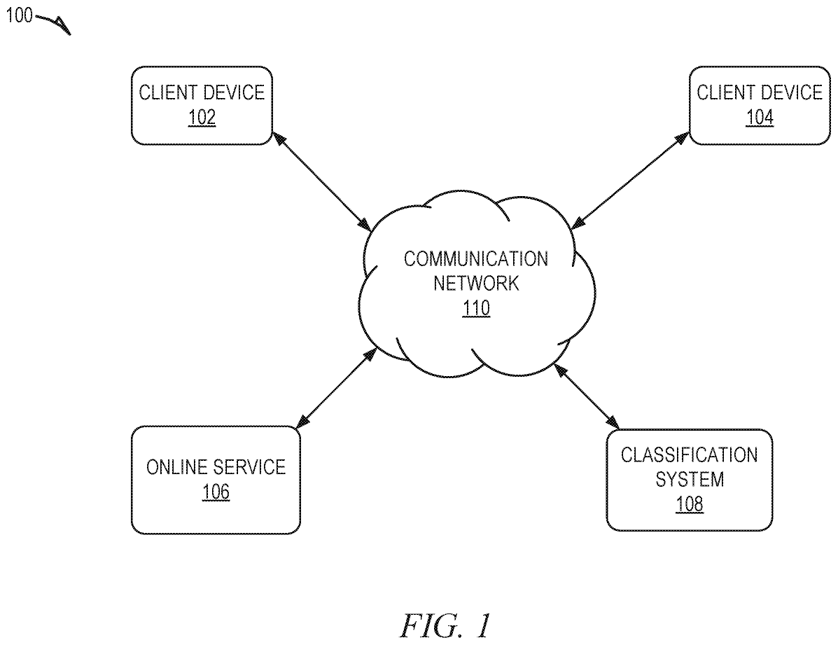

FIG. 1 shows an example system 100, wherein electronic devices communicate via a network for purposes of exchanging content and other data. As shown, multiple devices (i.e., client device 102, client device 104, online service 106, and classification system 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

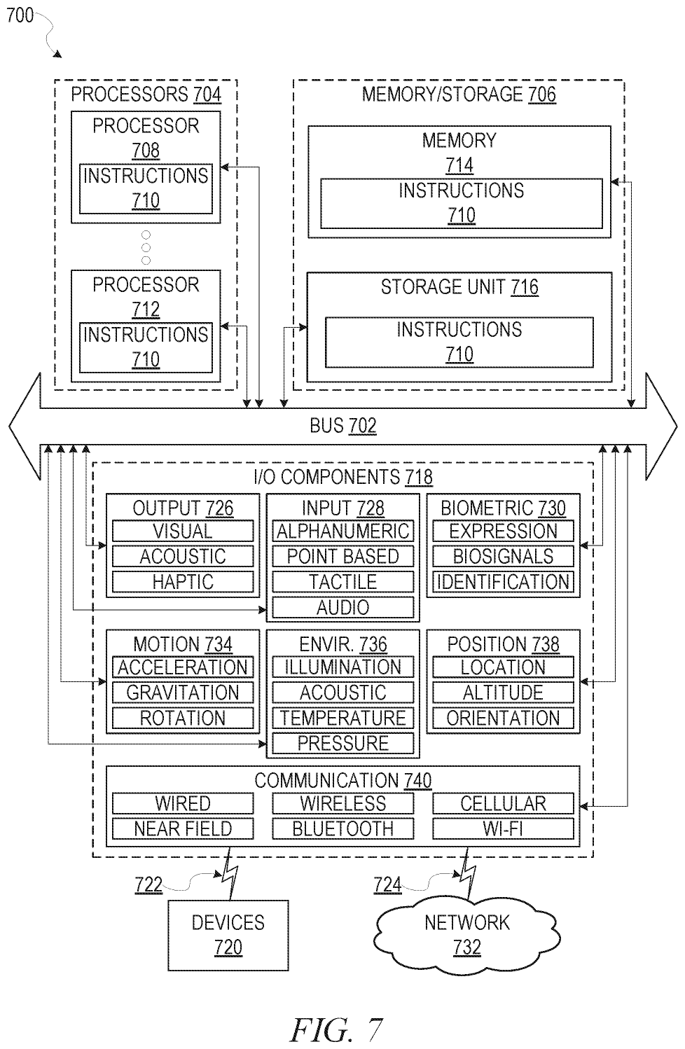

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 700 shown in FIG. 7.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users interact with the online service 106 to utilize the services provided by the online service 106. Users communicate with and utilize the functionality of the online service 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the online service 106 may concurrently accept connections from and interact with any number of client devices 102, 104. The online service 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the online service 106 via a client-side application installed on the client devices 102 and 104. In some embodiments, the client-side application includes a component specific to the online service 106. For example, the component may be a stand-alone application, one or more application plug-ins, and/or a browser extension. However, the users may also interact with the online service 106 via a third-party application, such as a web browser, that resides on the client devices 102 and 104 and is configured to communicate with the online service 106. In either case, the client-side application presents a user interface (UI) for the user to interact with the online service 106. For example, the user interacts with the online service 106 via a client-side application integrated with the file system or via a webpage displayed using a web browser application.

The online service 106 is one or more computing devices configured to provide a service that is accessible online. The service may be any type of service, such as a banking service, online social networking service, data management service, search service, etc. For example, the online service 106 may provide a social networking service that allows a user to post content and view content posted by other users of the social networking service. An example of a social networking service is LINKEDIN.

As part of its provided service, the online service 106 may classify data items. For example, an online social networking service may classify content posted by users to determine what content to present to users of the social networking service and/or whether to present the content. The classification labels assigned to the content may identify a category of the content or whether the content violates terms of the online social networking service. The online social networking service may present content items based on the classification labels, such as to exclude content that is deemed to violate the terms of the online social networking service and/or present content to users that the users are likely to like. While the example of classifying content for an online social networking service is used, this is just one example and is not meant to be limiting. The online service 106 may be any type of service that may classify data items for any of number of purposes.

The online service 106 uses the functionality of the classification system 108, which assigns classification labels to data items. Although the classification system 108 and the online service 106 are shown as separate entities, this is just for ease of explanation and is not meant to be limiting. In some embodiments, the classification system 108 is incorporated as part of the online service 106.

The classification system 108 is one or more computing device configured to assign classification labels to data items. The classification system 108 uses a combination of human labelers and text classification models to classify data items. The classification system 108 receives data items from the online service 106, which the classification system 108 provides to human labelers to be classified. For example, the classification system 108 provides a user interface that the human labelers may access to view the data items and assign a classification label to the data item. The human classifies may use a client device 102, 104 to communicate with the classification system 108, either directly or through the online service 106, to access the classification interface. The classification interface presents the data items to the human labelers (e.g., on a display of the client device 102) and provides user interface elements, such as buttons, text boxes, etc., that the human labelers may use to select appropriate classification labels to assign to the data items.

A classification system uses a text classification model to automatically detect labelling errors made by human labelers. The text classification model may be trained using a set of verified or unverified labelling data. The set of verified labelling data includes labels assigned to data items that have been verified for accuracy. For example, the data items may have been reviewed and labeled with the same label by multiple labelers, indicating a high level of confidence that the data item was labeled correctly. The unverified labeling data may come from a multitude of sources including but not restricted to crowd-sourcing, external vendors, or user-generated. The resulting text classification model receives a data item as input and in turn outputs probability values indicating a likelihood that each of a set of classification labels properly label the input data item. A data item is any type of data, such as a document, image, audio file, etc.

The classification system uses the text classification model to double check the classification labels assigned to data items by the human labelers. For example, the classification system uses a data item as input into the text classification system to determine a classification label for the data item (e.g., the classification label with the highest probability value) and then compares the classification label determined by the classification model to the classification label assigned to the data item by the human labeler. If the classification label determined by the text classification model matches the classification label assigned by the human labeler, the classification label assigned by the human labeler is most likely correct and no further action is taken by the classification system.

Alternatively, if the classification label determined by the text classification model does not match the classification label assigned by the human labeler, the classification label assigned by the human labeler may not be correct. In this case, the classification system may investigate further to determine whether the classification label assigned by the human labeler is correct. To accomplish this, the classification system uses a model interpretability technique to determine why the text classification model determined the classification label for the data item. A model interpretability technique (e.g., Local Interpretable Model-Agnostic Explanations (LIME)) provides data that explains how a model made a determination. For example, the model interpretability technique provides a listing of the features that contributed to the classification model determining a classification label for the data item. A feature is an individual measurable property or characteristic that is considered by a model when analyzing an input text. The text classification model analyzes a data item based on multiple features to provide the resulting probability values for the classification labels. The model interpretability technique provides a listing of the features that contributed to the classification model's determination, as well as values corresponding to the listed features that indicate a level at which the feature contributed and/or was relied upon by the text classification model in making its determination.

The classification system uses the output of the model interpretability technique to determine a probability value indicating a likelihood that the text classification model properly classified the data item (e.g., the classification label determined by the text classification model properly classifies the input data item). The classification system compares the probability value to a threshold probability value to determine whether the text classification model properly classified the data item. For example, if the probability value is below the threshold probability value, the classification system may determine that the text classification model did not properly classify the data item and the classification label assigned by the human labeler may be used to classify the data item. In contrast, if the probability value transgresses the threshold probability value (e.g., the probability value meets or is greater than the threshold probability value), the classification system may determine that the text classification model did properly classify the data item. In this case, the classification system may use the classification label determined by the text classification model, rather than the classification label determined by the human labeler, to classify the data item. The classification system may also update records associated with the human labelers to include the recorded errors. The records may be used to identify human labelers that are regularly mislabeling data items, train the labelers, identify ambiguities in the labelling guidelines, etc.

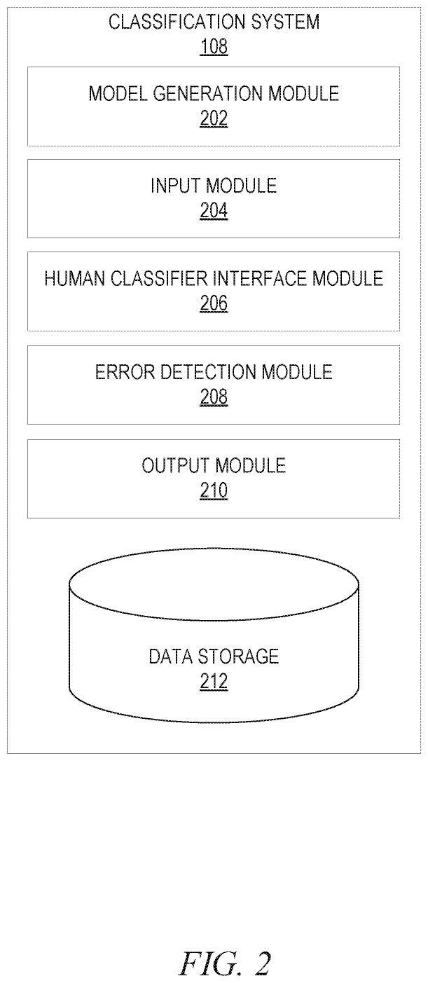

FIG. 2 is a block diagram of a classification system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the classification system 108 to facilitate additional functionality that is not specifically described herein. Furthermore, the various functional modules depicted in FIG. 2 may reside on a single computing device or may be distributed across several computing devices in various arrangements such as those used in cloud-based architectures. For example, the various functional modules and components may be distributed amongst computing devices that facilitate both the classification system 108 and the online service 106.

As shown, the classification system 108 includes a model generation module 202, an input module 204, a human classifier interface module 206, an error detection module 208, an output module 210, and a data storage 212.

The model generation module 202 generates a text classification model based on historical classification data. The historical classification data includes previously reviewed data items and the classification labels assigned to the data items by human labelers. To improve the quality of the generated text classification model, the model generation module 202 may use verified classification data to train the text classification model. Verified classification data includes historical classification data that is determined to have a higher probability of accurately classifying a data item. For example, the verified classification data may include text classification data for data items that were classified consistently by multiple human classifiers. That is, the verified classification data includes historical classification data for data items that were assigned the same classification label by multiple (e.g., 2, 3, 4, etc.) human labelers.

The text classification model generated by the model generation module 202 receives a data item as input and outputs a set of probability values corresponding to a set of potential classification labels. Each probability value indicates the likelihood that its corresponding classification label properly classifies the data item. Accordingly, the classification label with the highest probability value is determined to have the highest likelihood of properly classifying the data item.

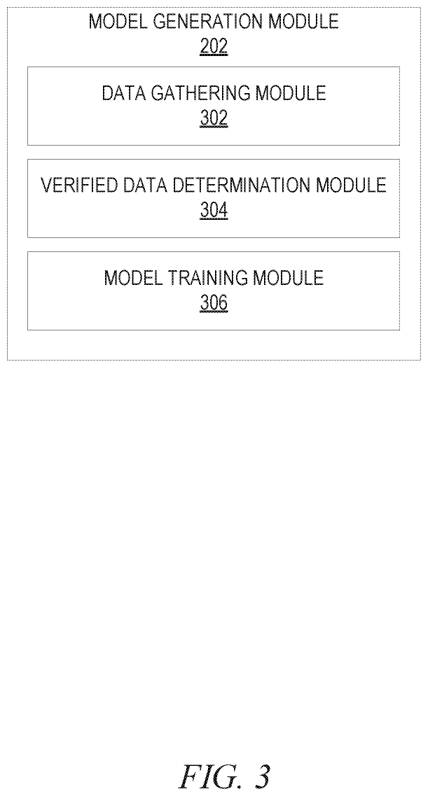

The model generation module 202 may generate multiple text classification models using the different and/or partially different sets of classification data. The functionality of the model generation module 202 is described in greater detail in relation to FIG. 3.

The input module 204 receives data items to be classified by the classification system 108. A data item may be any type of digital data item, such as a text file, image, audio file, etc. In some embodiments, the data items are content posted or shared on a social networking service, such as a social networking service provided by the online service 106.

The input module 204 may receive the data items from the online service 106, which transmits the data items to the classification system 108. As another example, the input module 204 transmits a request to the online service 106 for the data items. As another example, the input module 204 accesses the data items from the data storage 212. In embodiments in which the classification system 108 is incorporates as part of the online service 106, the data storage 212 may be shared by the classification system 108 and the online service 106. Accordingly, the input module 204 may access the data items directly form the data storage 212.

The human classifier interface module 206 enables human classifiers to classify the received data items. That is, the human classifier interface module 206 presents each data item to one or more human classifiers and enables the human classifier(s) to assign a classification label to the data item. To accomplish this, the human classifier interface module 206 provides a human classifier interface on a client device 102, 104 of the human classifier. The human classifier uses their client device 102, 104 to communicate with the classification system 108, either directly or via the online service 106, and access the human classifier interface provided by the human classifier interface module 206.

The human classifier interface is a user interface that presents data items to a human classifier. For example, the human classifier interface causes a data item, such as a text file or image file, to be presented on a display of the human classifier's client device 102, 104. The human classifier interface includes user interface elements, such as buttons, text boxes, etc., that allow a human classifier to assign a classification label to the data item. For example, the human classifier interface may present a list of the possible classification labels and allow a user to select the classification label to be assigned to the data item.

The human classifier interface causes data describing the classification labels selected by the human classifiers for a data items to be returned to the classification system 108, where they are stored in the data storage 212. For example, the human classifier interface module 206 stores data identifying the data item, such as a unique identifier, along with data identifying the classification label selected by the human classifier in the data storage 212.

As explained earlier, human labelers sometimes mislabel and/or inconsistently label data items. This is may be due to a variety of reasons, such as ambiguous labelling guidelines, human fatigue, varying expertise by individual labelers, etc. The error detection module 208 determines whether a human labeler has mislabeled a data item (e.g., assigned the incorrect classification label to the data item). To accomplish this, the error detection module 208 uses the classification models generated by the model generation module 202 to determine classification labels for the data items. That is, the error detection module 208 uses the data item as input into a text classification model to determine the classification label assigned the highest probability value by the text classification model. In some embodiment, the error detection module 208 may use the data item as input into multiple text classification models to determine a set of classification labels assigned to the data item by the text classification models. The error detection module 208 then determines a classification label based on the set of classification labels, such as the classification label that was determined by a majority of the text classification models.

The error detection module 208 compares the classification label determined for the data item by the text classification models to the classification label assigned to the data item by the human labeler to determine whether the human labeler correctly labeled the data item or mislabeled the data item.

If the classification label(s) determined by the text classification model matches the classification label assigned by the human labeler, the error detection module 208 determines that the classification label assigned by the human labeler is most likely correct and no further action may be taken.

Alternatively, if the classification label determined by the text classification model does not match the classification label assigned by the human labeler, the error detection module 208 determines that the classification label assigned by the human labeler may not be correct. In this case, the error detection module 208 may investigate further to determine whether the classification label assigned by the human labeler is correct.

To accomplish this, the error detection module 208 uses a model interpretability technique to determine why the text classification model determined the classification label for the data item. A model interpretability technique (e.g., Local Interpretable Model-Agnostic Explanations (LIME)) provides data that explains how a model made a determination. For example, the model interpretability technique provides a listing of the features that contributed to the classification model determining a classification label for the data item. A feature is an individual measurable property or characteristic that is considered by a model when analyzing an input text. The text classification model analyzes a data item based on multiple features to provide the resulting probability values for the classification labels. The model interpretability technique provides a listing of the features that contributed to the classification model's determination, as well as values corresponding to the listed features that indicate a level at which the feature contributed and/or was relied upon by the text classification model in making its determination.

The error detection module 208 uses the output of the model interpretability technique to determine a probability value indicating a likelihood that the text classification model properly classified the data item (e.g., the classification label determined by the text classification model properly classifies the input data item). The error detection module 208 compares the probability value to a threshold probability value to determine whether the text classification model properly classified the data item. For example, if the probability value is below the threshold probability value, the error detection module 208 may determine that the text classification model did not properly classify the data item and the classification label assigned by the human labeler may be used to classify the data item. In contrast, if the probability value transgresses the threshold probability value (e.g., the probability value meets or is greater than the threshold probability value), the error detection module 208 may determine that the text classification model did properly classify the data item. In this case, the error detection module 208 may use the classification label determined by the text classification model, rather than the classification label determined by the human labeler, to classify the data item.

The output module 210 updates the data storage 212 based on the output of the error detection module 208. For example, the output module 210 may update the data storage 212 to change the classification label assigned to a data item from the classification label assigned to the data item by a human labeler to the classification label determined by the text classification model. The output module 210 may also update records associated with each human labeler to indicate whether the classification label assigned by the human labeler was determined to be correct or an error by the error detection module 208. This record may be used to identify human labelers that are consistently mislabeling data items so that the human labelers may be provided with additional training. Further, the records may be used to identify the type of data items that are being consistently mislabeled by multiple human labelers. This information may be used to revise the labelling guidelines to provide clearer guidance to the human labelers.

FIG. 3 is a block diagram of a model generation module 202, according to some example embodiments. To avoid obscuring the inventive subject matter with unnecessary detail, various functional components (e.g., modules) that are not germane to conveying an understanding of the inventive subject matter have been omitted from FIG. 3. However, a skilled artisan will readily recognize that various additional functional components may be supported by the model generation module 202 to facilitate additional functionality that is not specifically described herein. Furthermore, the various functional modules depicted in FIG. 3 may reside on a single computing device or may be distributed across several computing devices in various arrangements such as those used in cloud-based architectures. For example, the various functional modules and components may be distributed amongst computing devices that facilitate both the classification system 108 and the online network 106.

As shown, the model generation module 202 includes a data gathering module 302, a verified data determination module 304, and a model training module 306. The data gathering module 302 gathers historical classification data for use in generating a text classification model. For example, the data gathering module 302 gathers the historical classification data from the data storage 212. The historical classification data includes previously reviewed data items and the classification labels assigned to the data items by human labelers.

To improve the quality of the generated text classification model, the verified data determination module 304 identities verified classification data for use to train the text classification model. Verified classification data includes historical classification data that is determined to have a higher probability of accurately classifying a data item. For example, the verified classification data may include text classification data for data items that were classified consistently by multiple human classifiers. That is, the verified classification data includes historical classification data for data items that were assigned the same classification label by multiple (e.g., 2, 3, 4, etc.) human labelers.

The verified data determination module 304 may search the historical classification data gathered by the model generation module 202 to find a subset of the historical classification data that is considered to be verified. For example, the verified data determination module 304 identifies historical classification data for data items that were assigned classification labels consistently by multiple human classifiers.

The model training module 306 uses the verified classification data to generate a text classification model. The text classification model generated by the model training module 306 receives a data item as input and outputs a set of probability values corresponding to a set of potential classification labels. Each probability value indicates the likelihood that its corresponding classification label properly classifies the data item. Accordingly, the classification label with the highest probability value is determined to have the highest likelihood of properly classifying the data item. The model training module 306 may generate multiple text classification models using the different and/or partially different sets of classification data.

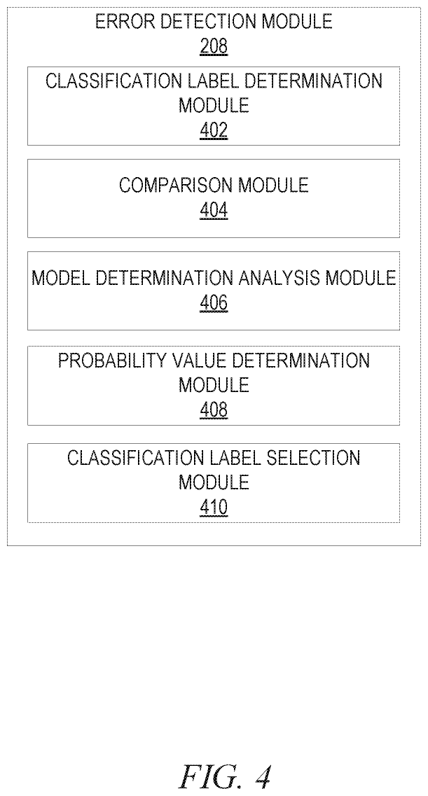

FIG. 4 is a block diagram of a error detection module 208, according to some example embodiments. To avoid obscuring the inventive subject matter with unnecessary detail, various functional components (e.g., modules) that are not germane to conveying an understanding of the inventive subject matter have been omitted from FIG. 4. However, a skilled artisan will readily recognize that various additional functional components may be supported by the error detection module 208 to facilitate additional functionality that is not specifically described herein. Furthermore, the various functional modules depicted in FIG. 4 may reside on a single computing device or may be distributed across several computing devices in various arrangements such as those used in cloud-based architectures. For example, the various functional modules and components may be distributed amongst computing devices that facilitate both the classification system 108 and the online network 106.

As shown, the error detection module 208 includes a classification label determination module 402, a comparison module 404, a model determination analysis module 406, a probability value determination module 408, and a classification label selection module 410.

The classification label determination module 402 uses the classification models generated by the model generation module 202 to determine classification labels for data items. That is, the classification label determination module 402 uses the data item as input into a text classification model to determine the classification label assigned the highest probability value by the text classification model. In some embodiment, the classification label determination module 402 may use the data item as input into multiple text classification models to determine a set of classification labels assigned to the data item by the text classification models. The classification label determination module 402 then determines a classification label based on the set of classification labels, such as the classification label that was determined by a majority of the text classification models.

The comparison module 404, compares the classification label determined for the data item by the text classification models to the classification label assigned to the data item by the human labeler to determine whether the human labeler correctly labeled the data item or mislabeled the data item.

If the classification label(s) determined by the text classification model matches the classification label assigned by the human labeler, the comparison module 404 determines that the classification label assigned by the human labeler is most likely correct and no further action may be taken.

Alternatively, if the classification label determined by the text classification model does not match the classification label assigned by the human labeler, the comparison module 404 determines that the classification label assigned by the human labeler may not be correct. In this case, the comparison module 404 notifies the model determination analysis module 406 to determine why the text classification model determined the classification label for the data item.

The model determination analysis module 406, uses a model interpretability technique to determine why the text classification model determined the classification label for the data item. A model interpretability technique (e.g., Local Interpretable Model-Agnostic Explanations (LIME)) provides data that explains how a model made a determination. For example, the model interpretability technique provides a listing of the features that contributed to the classification model determining a classification label for the data item. A feature is an individual measurable property or characteristic that is considered by a model when analyzing an input text. The text classification model analyzes a data item based on multiple features to provide the resulting probability values for the classification labels. The model interpretability technique provides a listing of the features that contributed to the classification model's determination, as well as values corresponding to the listed features that indicate a level at which the feature contributed and/or was relied upon by the text classification model in making its determination.

The probability value determination module 408 uses the output of the model determination analysis module 406 to determine a probability value indicating a likelihood that the text classification model properly classified the data item (e.g., the classification label determined by the text classification model properly classifies the input data item).

The classification label selection module 410 compares the probability value deter mined by the model determination analysis module 406 to a threshold probability value to determine whether to select the classification label assigned by the human labeler or the classification label determined by the text classification model to the data item. For example, if the probability value is below the threshold probability value, the classification label selection module 410 determines that the text classification model did not properly classify the data item and selects the classification label assigned by the human labeler to classify the data item. In contrast, if the probability value transgresses the threshold probability value (e.g., the probability value meets or is greater than the threshold probability value), the classification label selection module 410 determines that the text classification model did properly classify the data item. In this case, the classification label selection module 410 selects the classification label determined by the text classification model, rather than the classification label determined by the human labeler, to classify the data item.

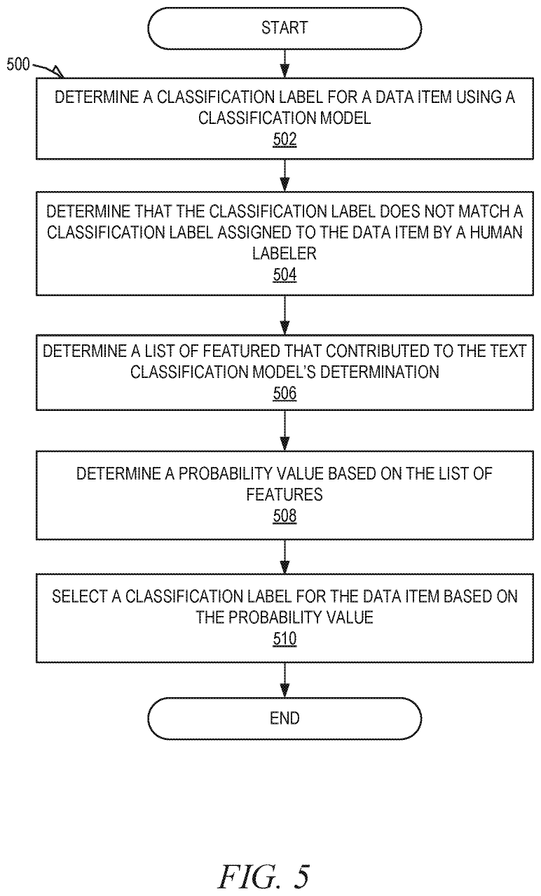

FIG. 5 is a flowchart showing an example method 500 of automatic detection of labeling errors, according to certain example embodiments. The method 500 may be embodied in computer readable instructions for execution by one or more processors such that the operations of the method 500 may be performed in part or in whole by the classification system 108; accordingly, the method 500 is described below by way of example with reference thereto. However, it shall be appreciated that at least some of the operations of the method 500 may be deployed on various other hardware configurations and the method 500 is not intended to be limited to the classification system 108.

At operation 502, the classification label determination module 402 determines a classification label for a data item using a text classification model. That is, the classification label determination module 402 uses the data item as input into the text classification model to determine the classification label assigned the highest probability value by the text classification model. In some embodiment, the classification label determination module 402 may use the data item as input into multiple text classification models to determine a set of classification labels assigned to the data item by the text classification models. The classification label determination module 402 then determines a classification label based on the set of classification labels, such as the classification label that was determined by a majority of the text classification models.

At operation 504, the comparison module 404 determines that the classification label does not match a classification label assigned to the data item by a human labeler. The comparison module 404, compares the classification label determined for the data item by the text classification models to the classification label assigned to the data item by the human labeler to determine whether the human labeler correctly labeled the data item or mislabeled the data item.

If the classification label(s) determined by the text classification model matches the classification label assigned by the human labeler, the comparison module 404 determines that the classification label assigned by the human labeler is most likely correct and no further action may be taken. Alternatively, if the classification label determined by the text classification model does not match the classification label assigned by the human labeler, the comparison module 404 determines that the classification label assigned by the human labeler may not be correct.

At operation 506, the model determination analysis module 406 determines a list of features that contributed to the text classification's determination. The model determination analysis module 406 uses a model interpretability technique to determine why the text classification model determined the classification label for the data item. A model interpretability technique (e.g., Local Interpretable Model-Agnostic Explanations (LIME)) provides data that explains how a model made a determination. For example, the model interpretability technique provides a listing of the features that contributed to the classification model determining a classification label for the data item. A feature is an individual measurable property or characteristic that is considered by a model when analyzing an input text. The text classification model analyzes a data item based on multiple features to provide the resulting probability values for the classification labels. The model interpretability technique provides a listing of the features that contributed to the classification model's determination, as well as values corresponding to the listed features that indicate a level at which the feature contributed and/or was relied upon by the text classification model in making its determination.

At operation 508, the probability value determination module 408 determines a probability value based on the list of features. The probability value determination module 408 uses the output of the model determination analysis module 406 to determine a probability value indicating a likelihood that the text classification model properly classified the data item (e.g., the classification label determined by the text classification model properly classifies the input data item).

At operation 510, the classification label selection module 410 selects a classification label for the data item based on the probability value. The classification label selection module 410 compares the probability value determined by the model determination analysis module 406 to a threshold probability value to determine whether to select the classification label assigned by the human labeler or the classification label determined by the text classification model to the data item. For example, if the probability value is below the threshold probability value, the classification label selection module 410 determines that the text classification model did not properly classify the data item and selects the classification label assigned by the human labeler to classify the data item. In contrast, if the probability value transgresses the threshold probability value (e.g., the probability value meets or is greater than the threshold probability value), the classification label selection module 410 determines that the text classification model did properly classify the data item. In this case, the classification label selection module 410 selects the classification label determined by the text classification model, rather than the classification label determined by the human labeler, to classify the data item.

### Software Architecture

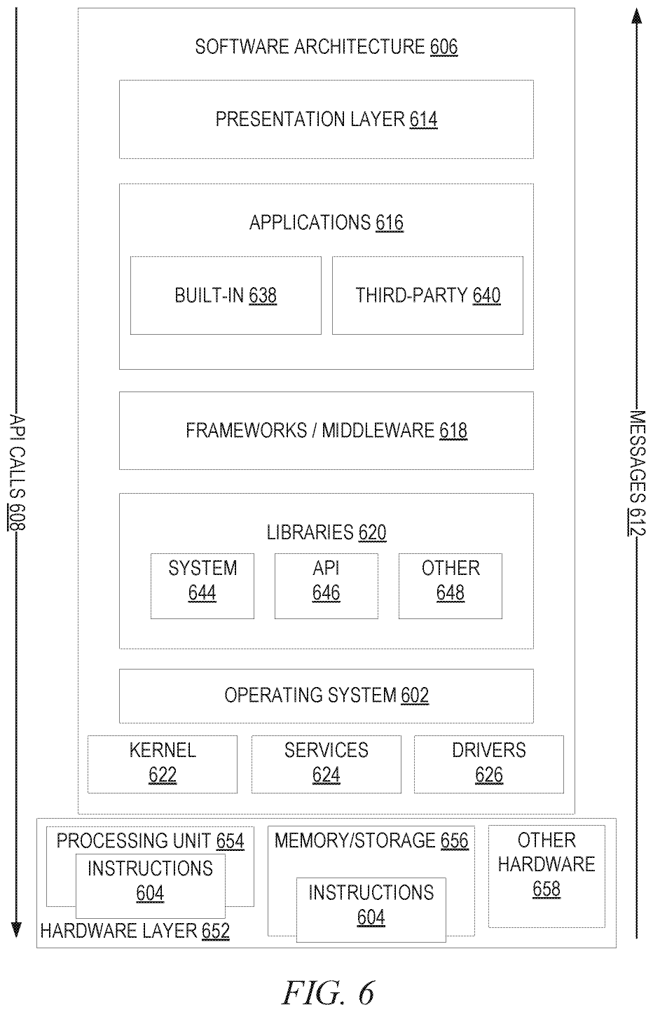

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 704, memory 714, and (input/output) I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage modules 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke application programming interface (API) calls 608 through the software stack and receive a response such as messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and, manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphical user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions 604 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 724 and coupling 722, respectively. For example, the communication components 740 may include a network interface component or other suitable device to interface with the network 732. In further examples, communication components 740 may include wired communication components, wireless communication components, cellular communication components, near field communication (NTC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF117, Ultra Code, UCC RSS-2D bar code, and other optical codes), or acoustic detection components (e.g., microphones to identify tagged audio signals). In addition, a variety of information may be derived via the communication components 740 such as location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 710 for execution by the machine 700, and includes digital or analog communications signals or other intangible medium to facilitate communication of such instructions 710. Instructions 710 may be transmitted or received over the network 732 using a transmission medium via a network interface device and using any one of a number of well-known transfer protocols.

“CLIENT DEVICE” in this context refers to any machine 700 that interfaces to a communications network 732 to obtain resources from one or more server systems or other client devices 102, 104. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 732.

“COMMUNICATIONS NETWORK” in this context refers to one or more portions of a network 732 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 732 or a portion of a network 732 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 710 and data temporarily or permanently and may include, but is not be limited to; random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 710. The term “machine-readable medium” shall also be taken to include any medium, or combination of multiple media, that is capable of storing instructions 710 (e.g., code) for execution by a machine 700, such that the instructions 710, when executed by one or more processors 704 of the machine 700, cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 704) may be configured by software (e.g., an application 616 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 704 or other programmable processor 704. Once configured by such software, hardware components become specific machines 700 (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 704 configured by software to become a special-purpose processor, the general-purpose processor 704 may be configured as respectively different special-purpose processors (e.g., comprising different hardware components) at different times. Software accordingly configures a particular processor or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 702) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be perforated, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a network 732 (e.g., the Internet) and via one or more appropriate interfaces (e.g., an API). The performance of certain of the operations may be distributed among the processors 704, not only residing within a single machine 700, but deployed across a number of machines 700. In some example embodiments, the processors 704 or processor-implemented components may be located in a single geographic location (e.g., within a home environment, an office environment, or a server farm). In other example embodiments, the processors 704 or processor-implemented components may be distributed across a number of geographic locations.

“PROCESSOR” in this context refers to any circuit or virtual circuit (a physical circuit emulated by logic executing on an actual processor 704) that manipulates data values according to control signals (e.g., “commands,” “op codes,” “machine code,” etc.) and which produces corresponding output signals that are applied to operate a machine 700. A processor 704 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 704 may further be a multi-core processor having two or more independent processors 704 (sometimes referred to as “cores”) that may execute instructions 710 contemporaneously.

What is claimed is:

1. A method comprising:
determining, using a classification model, a first classification label for a data item;
determining that the first classification label determined for the data item by the classification model is different than a second classification label assigned to the data item by a human labeler;
in response to determining that the first classification label determined for the data item by the classification model is different than the second classification label assigned to the data item by a human labeler, determining, using a model interpretability technique, a list of features that contributed to the classification model determining the first classification label for the data item; and
determining, based on the list of features that contributed to the classification model, a probability value indicating a likelihood that the first classification label determined by the classification model properly classifies the data item.

2. The method of claim 1, further comprising:
in response to determining that the probability value is below the threshold probability value, determining that the second classification label appropriately classifies the data item.

3. The method of claim 1, further comprising:
in response to determining that the probability value meets or exceeds the threshold probability value, assigning the first classification label to the data item.

4. The method of claim 3, further comprising:
updating a record associated with the human labeler based on assigning the first classification label to the data item.

5. The method of claim 1, wherein the list of features lists each feature that contributed to the classification model determining the first classification label for the data item and a value corresponding to each respective feature that indicates a level at which the respective feature contributed to the classification model determining the first classification label for the data item.

6. The method of claim 1, wherein determining the probability value comprises:
determining, based on the list of features, a first feature that was a highest contributor to the classification model deter mining the first classification label for the data item; and
determining the probability value based on a predetermined weight assigned to the first feature.

7. The method of claim 1, wherein the model interpretability technique is Local Interpretable Model-Agnostic Explanations (LIME).

8. A system comprising:
one or more computer processors; and
one or more computer-readable mediums storing instructions that, when executed by the one or more computer processors, cause the system to perform operations comprising:
determining, using a classification model, a first classification label for a data item;
determining that the first classification label determined for the data item by the classification model is different than a second classification label assigned to the data item by a human labeler;
in response to determining that the first classification label determined for the data item by the classification model is different than the second classification label assigned to the data item by a human labeler, determining, using a model interpretability technique, a list of features that contributed to the classification model determining the first classification label for the data item; and
determining, based on the list of features that contributed to the classification model, a probability value indicating a likelihood that the first classification label determined by the classification model properly classifies the data item.

9. The system of claim 8, the operations further comprising:
in response to determining that the probability value is below the threshold probability value, determining that the second classification label appropriately classifies the data item.

10. The system of claim 8, the operations further comprising:
in response to determining that the probability value meets or exceeds the threshold probability value, assigning the first classification label to the data item.

11. The system of claim 10, the operations further comprising:
updating a record associated with the human labeler based on assigning the first classification label to the data item.

12. The system of claim 8, wherein the list of features lists each feature that contributed to the classification model determining the first classification label for the data item and a value corresponding to each respective feature that indicates a level at which the respective feature contributed to the classification model determining the first classification label for the data item.

13. The system of claim 8, wherein determining the probability value comprises:
determining, based on the list of features, a first feature that was a highest contributor to the classification model determining the first classification label for the data item; and
determining the probability value based on a predetermined weight assigned to the first feature.

14. The system of claim 8, wherein the model interpretability technique is Local Interpretable Model-Agnostic Explanations (LIME).

15. A non-transitory computer-readable medium storing instructions that, when executed by one or more computer processors of a computing system, cause the computing system to perform operations comprising:
determining, using a classification model, a first classification label for a data item;
determining that the first classification label determined for the data item by the classification model is different than a second classification label assigned to the data item by a human labeler;
in response to determining that the first classification label determined for the data item by the classification model is different than the second classification label assigned to the data item by a human labeler, determining, using a model interpretability technique, a list of features that contributed to the classification model determining the first classification label for the data item; and
determining, based on the list of features that contributed to the classification model, a probability value indicating a likelihood that the first classification label determined by the classification model properly classifies the data item.

16. The non-transitory computer-readable medium of claim 15, the operations further comprising:
in response to determining that the probability value is below the threshold probability value, determining that the second classification label appropriately classifies the data item.

17. The non-transitory computer-readable medium of claim 15, the operations further comprising:
in response to determining that the probability value meets or exceeds the threshold probability value, assigning the first classification label to the data item; and
updating a record associated with the human labeler based on assigning the first classification label to the data item.

18. The non-transitory computer-readable medium of claim 15, wherein the list of features lists each feature that contributed to the classification model determining the first classification label for the data item and a value corresponding to each respective feature that indicates a level at which the respective feature contributed to the classification model determining the first classification label for the data item.

19. The non-transitory computer-readable medium of claim 15, wherein determining the probability value comprises:
determining, based on the list of features, a first feature that was a highest contributor to the classification model determining the first classification label for the data item; and
determining the probability value based on a predetermined weight assigned to the first feature.

20. The non-transitory computer-readable medium of claim 15, wherein the model interpretability technique is Local Interpretable Model-Agnostic Explanations (LIME).
